(19) United States
(12) Patent Application Publication
(10) Pub. No.: US 2025/0205974 A1
(43) Pub. Date: Jun. 26, 2025

(54) APPARATUS AND METHOD OF MANUFACTURING A CAN END

(71) Applicant: Top Cap Holding GmbH, Kufstein (AT)

(72) Inventor: Gregor Anton Piech, Scheffau am Wilden Kaiser (AT)

(21) Appl. No.: 18/849,188

(22) PCT Filed: Mar. 7, 2023
(86) PCT No.: PCT/EP2023/055654

§ 371 Date: Sep. 20, 2024

(30) Foreign Application Priority Data
Mar. 22, 2022 (DE) 10 2022 106 622.3

(51) Int. Cl. B29C 65/00; B29L 31/56

(52) U.S. Cl. CPC B29C 66/81811; B29C 66/742; B29C 66/8322; B29L 2031/565

(57) ABSTRACT

An apparatus for manufacturing a can end, which has a can end part composed of sheet metal and at least one plastic part joined to the can end part, comprises two pressing tools that can be brought together and that form a press for pressing together the can end part and the plastic part; and an inductor for supplying an alternating electromagnetic field into the region of the press to inductively heat the can end part and thereby to join the can end part to the pressed-on plastic part. A fluid passage is formed in at least one of the pressing tools, with a temperature control apparatus being provided that is configured to convey a temperature control fluid through the fluid passage in order to stabilize the temperature of the press.

### CROSS-REFERENCE TO RELATED APPLICATIONS

This application is a national stage application under 35 U.S.C. 371 of PCT Application No. PCT/EP2023/055654, having an international filing date of Mar. 7, 2023, which claims the benefit of German Patent Application No. 102022106622.3, filed Mar. 22, 2022, the entire disclosure of each of which are hereby incorporated herein by reference.

### INTRODUCTION

The invention relates to an apparatus for manufacturing a can end that has a can end part composed of sheet metal and at least one plastic part joined to the can end part, wherein the apparatus comprises:
two pressing tools that can be brought together and that form a press for pressing together the can end part and the plastic part; and
an inductor for supplying an alternating electromagnetic field into the region of the press to inductively heat the can end part and thereby to join the can end part to the pressed-on plastic part.

Can ends for beverage cans, food cans and the like typically have an opening section that can be moved, via a tear-open member fastened thereto, out of the can plane in order to open the can. Reclosable can ends are also known in which a sealing frame composed of a plastic material, connected to the metallic end surface, and surrounding the opening region cooperates with a closure unit composed of a plastic material and connected to the metallic opening section. Can ends can further be laminated with a plastic film, for example, to cover a microgap in a sealing manner. A particularly stable connection of sealing frames, closure units, films and other plastic parts to metallic can end parts can be achieved by means of pressing and heating.

The plastic part is partly melted by the inductive heating and is thereby connected in a bonded manner to the sheet metal part. The inductive heating has the advantage here that only the sheet metal part is directly heated since eddy currents can only be generated in the sheet metal part by the induction. The plastic part, in contrast, is indirectly heated by the metal part, whereby in particular the side of the plastic part contacting the metal part, but not necessarily the total surface of the plastic part, is partly melted.

A high process speed and high volumes are generally required during the manufacture of can ends. Furthermore, the production of can ends is subject to a strong price pressure. However, a fast pressing sequence is often accompanied by a reduction in the reliability of the joining process. Specifically, undesirably high waste can occur as a result of an insufficient joint strength. A subsequent processing of faulty can ends is undesirable due to the associated costs.

It is an object of the invention to enable a more reliable manufacture of can ends with simple means.

The object is satisfied, on the one hand, by an apparatus having the features of claim 1.

### SUMMARY

In accordance with the invention, a fluid passage is formed in at least one of the pressing tools, with a temperature control apparatus being provided that is configured to convey a temperature control fluid through the fluid passage in order to stabilize the temperature of the press.

The temperature control apparatus keeps the temperature of the press at least largely constant and thereby prevents a gradual heating of the pressing tools by the heated end parts. In an apparatus in accordance with the invention, a temperature drift of the press due to thermal conduction is therefore avoided and constant conditions are thus also ensured with a long time of use and a fast pressing sequence. The process safety is considerably increased in this manner. It has been shown that waste during the manufacture of can ends from a composite material can be considerably reduced or even virtually completely avoided by means of the invention.

If the application requires it, a fluid passage can be formed in each of the pressing tools, wherein the temperature control apparatus is configured to convey a temperature control fluid through each of the fluid passages in order to stabilize the temperature of the press.

The can end part is preferably produced from aluminum or from tin plate. The plastic part can in particular be a plastic film, preferably a film composed of polypropylene or polyethylene terephthalate. By means of an apparatus in accordance with the invention, it is also possible to join a plurality of possibly different plastic parts to one and the same metal part.

The pressing tools are preferably produced from a high-temperature resistant plastic, in particular from polyetherketone (PEK).

The temperature control fluid is preferably a liquid, for example, water. In principle, a gas could, however, also be provided as the temperature control fluid.

The one pressing tool can have a shape reciprocal to one side of the can end and the other pressing tool can have a shape reciprocal to the other side of the can end.

The inductor can be configured for a field frequency between 1 KHz and 100 kHz, in particular of approximately 20 KHz.

An apparatus in accordance with the invention can also be configured to manufacture a can end that has a can end part composed of sheet metal and a plurality of plastic parts joined to the can end part. Accordingly, the two pressing tools that can be brought together can form a press for pressing together the can end part and the plurality of plastic parts. The can end part can then be joined to all the pressed-on plastic parts during the inductive heating, in particular at the same time. In principle, it is also possible to join together a plurality of can end parts composed of sheet metal with one or more plastic parts by means of an apparatus in accordance with the invention.

The temperature control apparatus can have a cooling apparatus for cooling the temperature control fluid, a heating apparatus for heating the temperature control fluid and/or a fluid pump having a controllable conveying quantity. The temperature control apparatus can therefore counteract both a heating and a cooling of the press, if required. The temperature of the press can be adapted relatively quickly and easily via the quantity of the temperature control fluid conveyed through the fluid passage per unit of time.

The temperature control apparatus preferably has an electronic control device that is configured to control or to regulate the temperature of the temperature control fluid and/or of the press in accordance with a default value. This enables a particularly precise and continuous temperature control. The electronic control device can in particular be configured to continuously keep the temperature of the temperature control fluid and/or of the press at room temperature during the operation of the apparatus.

The inductor can be arranged at an outer surface of one of the pressing tools, preferably while forming a gap. It is then not necessary to receive the inductor in a complex manner in one of the pressing tools. In a favorable manner, the inductor is arranged at that outer surface which is disposed opposite a receiving region of the can end.

The fluid passage is preferably formed in that pressing tool at whose outer surface the inductor is arranged. This enables a particularly efficient temperature control.

An embodiment of the invention provides that at least one of the pressing tools is formed by two joined-together tool parts, with the fluid passage being formed between the joined-together tool parts. Such a pressing tool is comparatively simple and inexpensive to produce since the fluid passage only has to be formed as a recess or as an arrangement of oppositely disposed recesses and not, for instance, as a bore. In general, however, the pressing tool having the fluid passage can also be designed in one part, for example, as a 3D printed component.

The tool parts can be adhesively bonded to one another to ensure the leak tightness of the fluid passage.

Alternatively or additionally, the tool parts can be connected in a form-fitting manner to one another via projections and associated receivers in order to ensure a high strength. A particular advantage of a form-fitting connection is that it relieves the adhesive bond. Furthermore, a form-fitting connection provides an emergency tightness in the event of a failure of the adhesive bond.

The projections and the receivers can each have a dovetail-like cross-section. An undercutting engagement with a correspondingly high joint strength thereby results.

In accordance with an embodiment of the invention, the projections engage into the receivers while forming free spaces, with the free spaces being at least partly filled with a sealing and/or adhesive material. A separate layer composed of a sealing and/or adhesive material between the two tool parts is then not absolutely necessary.

The fluid passage can at least regionally have a spiral course in order to achieve a uniform, areal temperature control of the respective tool part. A round contact surface of a tool part with a spirally extending fluid passage can in particular be completely and uniformly covered.

In accordance with a further embodiment of the invention, the inductor comprises a strand, for example, a copper strand. The cross-section of the individual conductors can in this respect be dimensioned such that only low eddy currents occur as a result of magnetic transverse fields. It has been shown that on the presence of a temperature control apparatus as described above, it is not absolutely necessary to provide a water-cooled waveguide as an inductor so that the advantages of a strand can be used. In general, however, the inductor can be designed as a waveguide and may form a fluid passage itself.

The inductor can have a central section, in particular a spiral central section, extending in a base plane and at least one peripheral section, in particular an annular peripheral section, offset from the base plane. In accordance with a specific embodiment of the invention, the peripheral section is arranged peripherally around the can end located in the press. It is thereby possible to heat the can end part both from a flat side and from the margin, which enables a particularly fast and uniform heating process.

The invention also relates to a method of manufacturing a can end that has a can end part composed of sheet metal and at least one plastic part joined to the can end part, wherein the can end part and the plastic part are pressed together between two pressing tools and an alternating electromagnetic field is supplied into the region of the press by means of an inductor during the pressing together to inductively heat the can end part and thereby to join the can end part to the pressed-on plastic part.

The aforesaid object is also satisfied by a method in which the temperature of at least one of the pressing tools is stabilized by conveying a temperature control fluid through a fluid passage formed in the pressing tool.

A method in accordance with the invention can have method steps that result from the features specified above with respect to the apparatus.

The can end part and/or the plastic part is/are preferably coated with a bonding agent prior to the joining. The stability of the join connection can thereby be increased. The bonding agent preferably includes the same plastic as the plastic part to be connected to the can end part. A particularly good adhesion and thus a particularly firm join connection hereby result.

Further developments of the invention can also be seen from the dependent claims, from the description, and from the enclosed drawings.

### BRIEF DESCRIPTION OF THE DRAWINGS

The invention will be described in the following by way of example with reference to the drawings.

FIG. 1 shows a simplified sectioned perspective view of an apparatus in accordance with the invention for manufacturing a can end;

FIG. 2 shows a lateral sectional view of a pressing tool and an inductor of the apparatus shown in FIG. 1;

FIG. 3 shows an enlarged part representation of the pressing tool shown in FIG. 2;

FIG. 4 shows a plan view of the arrangement shown in FIG. 2; and

FIG. 5 shows a partly sectional view of a can end that is manufactured by means of the apparatus shown in FIG. 1.

### DETAILED DESCRIPTION

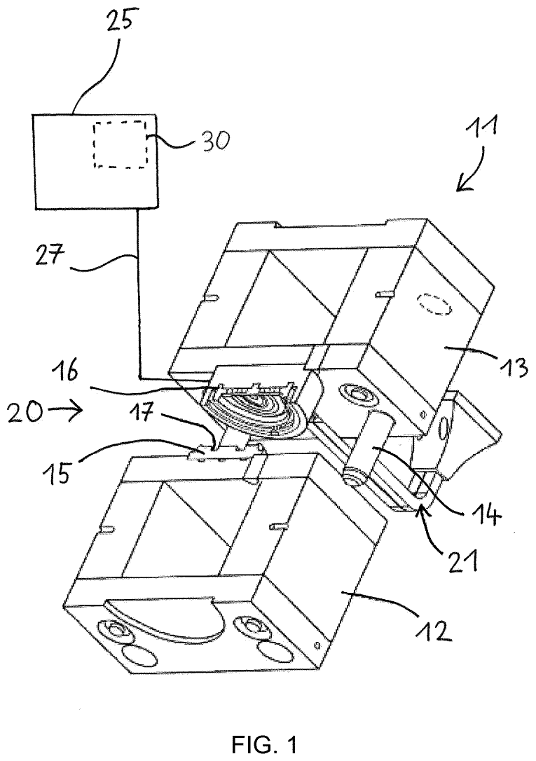

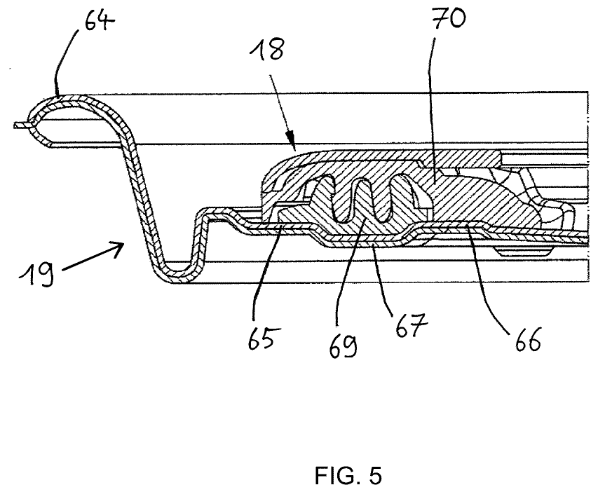

The apparatus shown in FIG. 1, which is designed in accordance with an embodiment of the invention, for manufacturing can ends comprises a pressing apparatus 11 having a lower rack 12 and an upper press part 13 movable relative thereto. The upper press part 13 is linearly displaceably guided at the lower rack 12 via a guide cylinder 14. Respective pressing tools 15, 16 composed of polyetherketone that form a press 20 to be opened and closed are attached to the lower rack 12 and to the upper press part 13. The pressing tool 15 attached to the lower rack 12 has a cavity 17 for receiving a closure element 18 (FIG. 5) of a can end 19. Furthermore, the pressing tool 15 attached to the lower rack 12 is modeled on the shape of the upper side of the can end 19. The pressing tool 16 attached to the upper press part 13 is modeled on the lower side of the can end 19.

An inductor 21 arranged in the region of the pressing apparatus 11 is configured in a generally known manner to supply an alternating electromagnetic field, which preferably has a frequency in the range from 1 kHz to 100 KHz, to the region of the press 20.

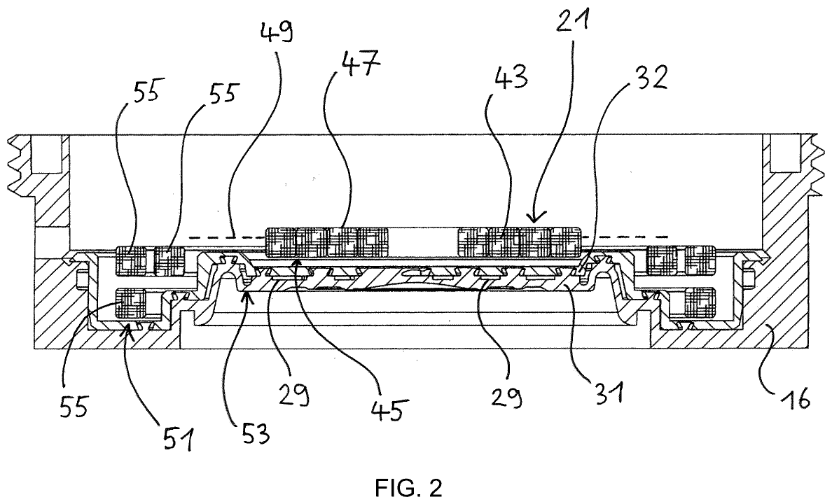

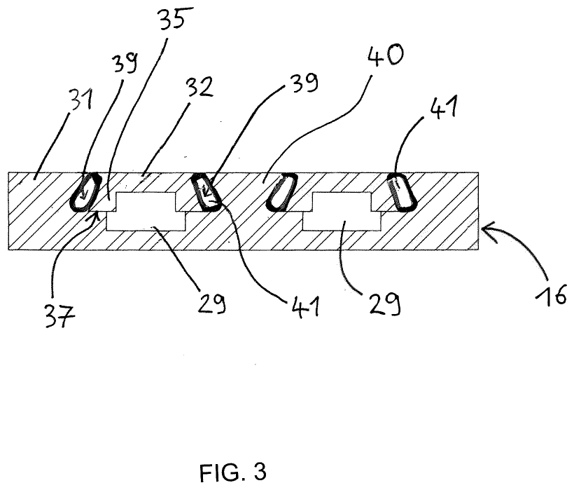

Furthermore, a temperature control apparatus 25, which is only shown schematically, is arranged in the region of the pressing apparatus 11 and is configured to convey water or a similar temperature control fluid via a line arrangement 27 through a fluid passage 29 that is formed in the upper pressing tool 16 and that can be seen in FIGS. 2 and 3. The fluid passage 29 preferably has a spiral course. The temperature control apparatus 25 is provided with a cooling apparatus and a controllable pump, which is not shown in detail in FIG. 1, however. Furthermore, the temperature control apparatus 25 has an electronic control device 30 that is adapted for a temperature control or temperature regulation.

As can in particular be seen in FIG. 3, the upper pressing tool 16 is formed by a lower tool part 31 and an upper tool part 32 joined thereto. The fluid passage 29 is formed between the joined-together tool parts 31, 32. The two tool parts 31, 32 are adhesively bonded to one another and are additionally connected in a form-fitting manner to one another, as will be explained in more detail below.

Projections 35 having a dovetailed cross-section are provided at the lower side of the upper tool part 32 and, as shown, engage into reciprocally shaped receivers 37 that are provided at the upper side of the lower tool part 31. Since the projections 35, as shown, have a smaller width than the receivers 37, free spaces 39 are formed at both sides of the projections 35. An adhesive 41 for adhesively bonding the tool parts 31, 32 is introduced into the free spaces 39. Due to the form-fitting engagement of the projections 35 into the receivers 37, the adhesive connection is relieved.

In accordance with FIG. 3, the receivers 37 are formed by recesses that are separated from one another by intermediate regions 40 of the lower tool part 31 that are likewise dovetailed. Dovetailed projections 35 therefore alternate with dovetailed intermediate regions 40.

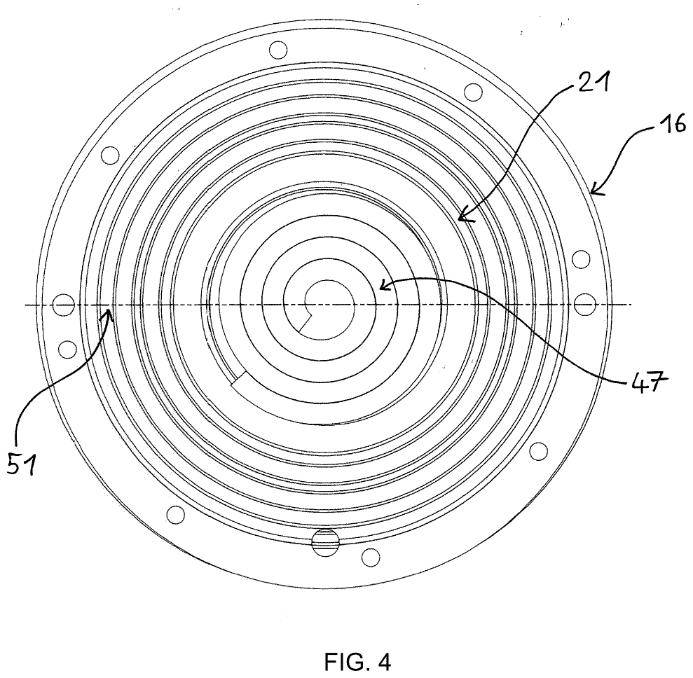

The shape of the inductor 21 in its press-side end region can be seen in FIG. 2. The transmission of the alternating field preferably does not take place via a waveguide, but rather via a copper strand 43 that has a plurality of individual conductors. The inductor 21 is arranged at the upper side of the upper pressing tool 16 while forming a gap 45 and is preferably adhesively bonded or molded to the upper pressing tool 16. Furthermore, the geometry of the inductor 21 is adapted to the outer shape of the upper pressing tool 16. The inductor 21 in particular has a central section 47 that extends spirally in a base plane 49. An annular peripheral section 51 of the inductor 21 is located offset from the base plane 49 and is arranged peripherally around the contact surface 53 provided for the can end 19 (FIG. 5). The annular peripheral section 51 is composed of a plurality of individual windings 55, as shown. The spiral course of the central section 47 is visible in the plan view in accordance with FIG. 4.

The can end 19 partly shown in FIG. 5 comprises a base body 64 composed of a sheet metal, in particular aluminum or tin plate. The base body 64 comprises a fixed metallic end region 65 and an upwardly pivotable opening section 8. The lower side of the can end 19 is laminated with a plastic film 67. In contrast, a closure element 18 that consists of a sealing frame 69 and a closure unit 70 is arranged at the upper side of the can end 19. The sealing frame 69 is connected to the fixed end region 65 while the closure unit 70 is connected to the upwardly pivotable opening section 66.

A method in accordance with the invention can be used to manufacture the can end 9 shown in FIG. 5 while using the apparatus shown in FIG. 1. For this purpose, the closure element 18 manufactured from plastic is placed into the lower pressing tool 15 such that the side facing the can end 19 faces upward. The base body 64 that was previously fitted with the plastic film 67 at its lower side is placed onto the closure element 18. Then, the press 20 is closed and the inductor 21 is put into operation.

Due to eddy currents in the metal, the base body 64 is heated, for example, to approximately 200° C. The heated base body 64 in turn heats the plastic film 67 and the closure element 18 that are thereby partly melted. A plastic weld connection thereby results between the metallic base body 64 and the plastic film 67, on the one hand, and the closure element 18, on the other hand. A bonding agent can be used to improve the plastic weld connection, preferably a bonding agent that includes the same plastic as the plastic film 67 or the closure element 18. After the welding of the plastic film 67 and the closure element 18 to the metallic base body 64 has taken place, the press 20 is opened and the complete can end 19 is removed.

During the operation of the press 20, the temperature control apparatus 25 (FIG. 1) ensures that the temperature of the pressing tools 15, 16 is stabilized. For this purpose, water is pumped through the fluid passage 29 of the upper pressing tool 16, which is connected to the line arrangement 27, by means of the temperature control apparatus 25. In this way, the temperature control apparatus 25 keeps the temperature of the press 20 approximately at room temperature and thereby prevents a gradual heating of the pressing tools 15, 16 by the heated base bodies 64. The process safety is thereby considerably increased. If an extended temperature control performance is required, an additional fluid passage, through which water is likewise pumped, could be formed in the lower pressing tool 15. Furthermore, the inductor 21 could be designed as a waveguide and could be water-cooled.

### REFERENCE NUMERAL LIST

11 pressing apparatus
12 lower rack
13 upper press part
14 guide cylinder
15 lower pressing tool
16 upper pressing tool
17 cavity
18 closure element
19 can end
20 press
21 inductor
25 temperature control apparatus
27 line arrangement
29 fluid passage
30 electronic control device
31 lower tool part
32 upper tool part
35 projection
37 receiver
39 free space
40 intermediate region
41 adhesive
43 copper strand
45 gap
47 central section
57 base plane
51 peripheral section
53 contact surface
55 single winding
64 base body
65 fixed end region
66 opening section
67 plastic film
69 sealing frame
70 closure unit

1-15. (canceled)

16. An apparatus for manufacturing a can end that has a can end part composed of sheet metal and at least one plastic part joined to the can end part, wherein the apparatus comprises:
two pressing tools that can be brought together and that form a press for pressing together the can end part and the plastic part; and
an inductor for supplying an alternating electromagnetic field into a region of the press to inductively heat the can end part and thereby to join the can end part to the plastic part, wherein
a fluid passage is formed in at least one of the pressing tools, with a temperature control apparatus being provided that is configured to convey a temperature control fluid through the fluid passage in order to stabilize the temperature of the press.

17. The apparatus in accordance with claim 16, wherein the temperature control apparatus has a cooling apparatus for cooling the temperature control fluid, a heating apparatus for heating the temperature control fluid, and/or a fluid pump having a controllable conveying quantity.

18. The apparatus in accordance with claim 16, wherein the temperature control apparatus has an electronic control device that is configured to control or to regulate the temperature of the temperature control fluid and/or of the press in accordance with a default value.

19. The apparatus in accordance with claim 16, wherein the inductor is arranged at an outer surface of one of the pressing tools, preferably while forming a gap.

20. The apparatus in accordance with claim 19, wherein the fluid passage is formed in that pressing tool at whose outer surface the inductor is arranged.

21. The apparatus in accordance with claim 16, wherein at least one of the pressing tools is formed by two joined-together tool parts, with the fluid passage being formed between the joined-together tool parts.

22. The apparatus in accordance with claim 21, wherein the tool parts are adhesively bonded to one another.

23. The apparatus in accordance with claim 21, wherein the tool parts are connected in a form-fitting manner to one another via projections and associated receivers.

24. The apparatus in accordance with claim 23, wherein the projections and the receivers each have a dovetail-like cross-section.

25. The apparatus in accordance with claim 23, wherein the projections engage into the receivers while forming free spaces, with the free spaces being at least partly filled with a sealing and/or adhesive material.

26. The apparatus in accordance with claim 16, wherein the fluid passage at least regionally has a spiral course.

27. The apparatus in accordance with claim 16, wherein the inductor comprises a strand.

28. The apparatus in accordance with claim 16, wherein the inductor has a central section extending in a base plane and at least one peripheral section offset from the base plane.

29. The apparatus in accordance with claim 28, wherein the central section is a spiral central section.

30. The apparatus in accordance with claim 28, wherein the at least one peripheral section is an annular peripheral section.

31. The apparatus in accordance with claim 28, wherein the peripheral section is arranged peripherally around the can end located in the press.

32. A method of manufacturing a can end that has a can end part composed of sheet metal and at least one plastic part joined to the can end part, wherein
the can end part and the plastic part are pressed together between two pressing tools, and
an alternating electromagnetic field is supplied into a region of the press using an inductor during the pressing together to inductively heat the can end part and thereby to join the can end part to the plastic part,
wherein a temperature of at least one of the pressing tools is stabilized by conveying a temperature control fluid through a fluid passage formed in the pressing tool.
